(19) United States
(12) Patent Application Publication
(10) Pub. No.: US 2025/0315057 A1
(43) Pub. Date: Oct. 9, 2025

(54) ROUTE TRAVERSAL USING REMOTE VEHICLE ASSISTANCE

(71) Applicant: Motional AD LLC, Boston, MA (US)

(72) Inventor: Gregory Scott Butron, Singapore (SG)

(21) Appl. No.: 18/555,375

(22) PCT Filed: Apr. 14, 2023
(86) PCT No.: PCT/US2023/018668

§ 371 Date: Oct. 13, 2023

Related U.S. Application Data
(60) Provisional application No. 63/435,961, filed on Dec. 29, 2022.

(51) Int. Cl. G05D 1/622; G05D 1/227; G05D 107/13; G05D 109/10

(52) U.S. Cl. CPC G05D 1/622; G05D 1/227; G05D 2107/13; G05D 2109/10

(57) ABSTRACT

Provided are methods for route traversal using remote vehicle assistance, which can include a method. The method includes: identifying a condition on a route traveled by a vehicle that inhibits movement of the vehicle along the route; sending an assistance request to a remote operator; receiving an updated trajectory for the vehicle to travel along the route, the updated trajectory including one or more segments; evaluating whether the vehicle can be controlled to safely traverse a first segment with a safe stop upon completion of traversal of the first segment; determining that the vehicle can be controlled to safely traverse the first segment with a safe stop; and upon determining that the vehicle can be controlled to traverse the first segment with a safe stop upon completion of the traversal of the first segment, controlling the vehicle to traverse the first segment. Systems and computer program products are also provided.

### CROSS-REFERENCE TO RELATED APPLICATIONS

This application claims the benefit of the priority date of U.S. Provisional Patent Application No. 63/435,961, filed Dec. 29, 2022.

### BACKGROUND

Autonomous or semi-autonomous vehicles include various electronic components to facilitate operations of the vehicles, e.g., sensors to gather information about the surrounding environment, processors to process the sensor information to control steering or braking, or both, among others. The various electronic components exchange information among themselves, or with external remote servers, using message exchanges

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of an implementation of a process for route traversal using remote vehicle assistance;

FIG. 6 is a diagram of an example of a road environment;

FIG. 7 is a diagram of an implementation of a process for route traversal using remote vehicle assistance; and

FIG. 8 is a diagram of an example of a road environment.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement route traversal using remote assistance. When a vehicle traveling along a route encounters a situation inhibiting movement of the vehicle, and an on-board controller determines that the vehicle cannot resolve the situation autonomously, the controller controls the vehicle to come to a safe stop (e.g., stop in a location with negligible probability of a crash) and then transmits an assistance request to a remote operator of the vehicle. In response, the controller receives a remote vehicle assistance (RVA) message with an updated trajectory for the vehicle from the remote operator, the updated trajectory including one or more segments. Before traversing any particular segment of the one or more segments, the controller checks whether the segment has a secure location at the end at which, or in proximity to which, the vehicle can perform a safe stop, e.g., depending on environmental conditions. Based on determining that the segment has a safe stop location at the end, the controller controls the vehicle to traverse the segment. At the end of the segment, the controller checks whether the next segment has a safe stop location at the end, and controls the vehicle to traverse the next segment accordingly.

By virtue of the implementation of systems, methods, and computer program products described herein, techniques for route traversal using remote assistance. The disclosed techniques can ensure that a vehicle executes RVA operations safely even if the network connection with the remote operator is lost. Performing a safe stop of the vehicle before requesting assistance guarantees that execution of RVA commands starts from a safe state. Once a RVA message is received, the vehicle can proceed to perform operations executing the commands (or stop and not execute the commands) even if the remote operator is disconnected, because each operation the vehicle performs (e.g., traversal of a segment) transitions the vehicle from one safe state to the next safe state. The techniques enable safe operation of a vehicle even when the vehicle communicates with the remote operator through an unreliable network that has high latency or message loss, or both. The RVA message from the operator is made atomic and time-insensitive to overcome latency and possible disconnections, addressing any temporal mismatch between when the operator sees a scenario and when the responsive RVA commands are executed. Even if the remote operator disconnects at any time, the vehicle can be operated to successfully resolve the encountered situation.

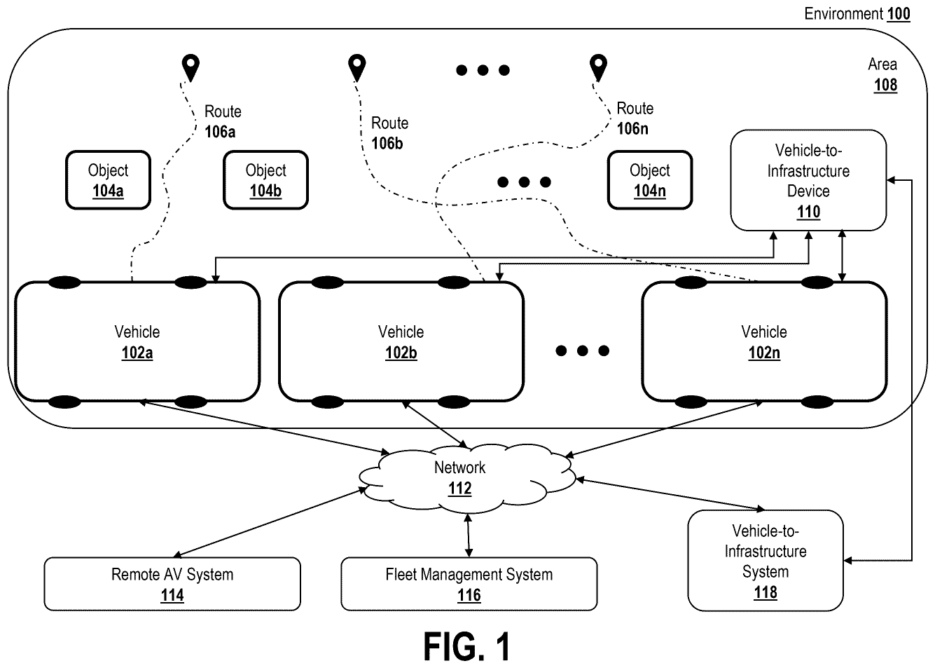

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

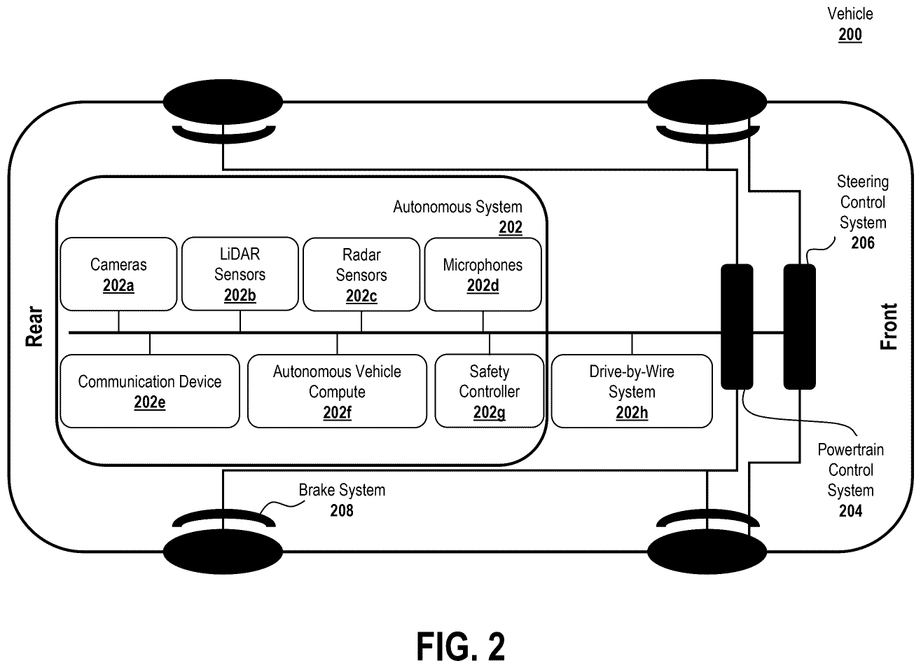

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like). In some embodiments, fleet management system 116 includes one or more automated and/or human vehicle operators that can send RVA messages to vehicles 102 with updated trajectories.

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally. or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In some embodiments, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

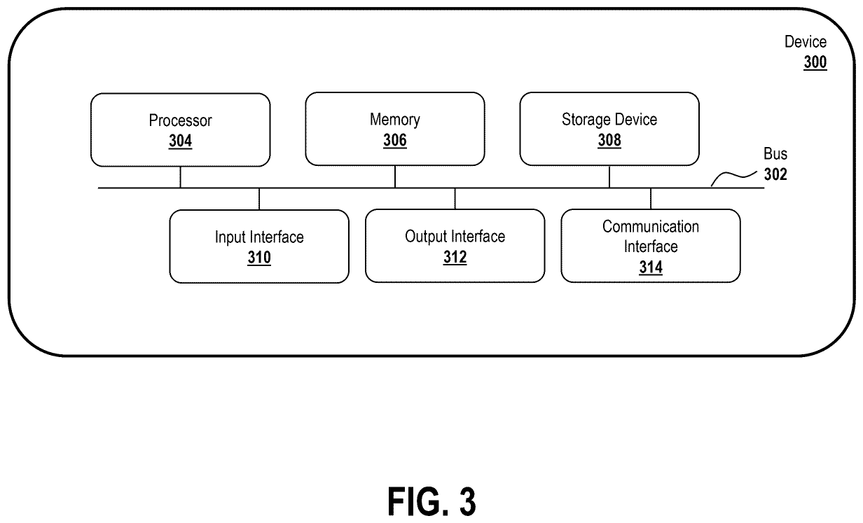

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

In some embodiments, communication device 202e includes at least one device configured to be in communication with a remote operator of the vehicle 200, e.g., over network 112. For example, the communication device 202e can include one or more cellular transceivers to communicate with the remote operator (e.g., a remote operator included in or associated with fleet management system 116), such as over a 4G or 5G wireless network. In some embodiments, the communication device 202e is operated to transmit assistance requests to the remote operator. In some embodiments, the communication device 202e is operated to receive updated trajectories (e.g., included in RVA messages) from the remote operator.

Autonomous vehicle compute 202f include at least one device configured to be in communication with cameras 202a, LIDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102, such as autonomous system 202 and/or autonomous vehicle compute 400), at least one device of fleet management system 116, at least one device of vehicle-to-infrastructure system 118, at least one device of vehicle-to-infrastructure device 110, and/or one or more devices of network 112 (e.g., one or more devices of a system of network 112). In some embodiments, one or more devices of vehicles 102 (e.g., one or more devices of a system of vehicles 102, such as autonomous system 202 and/or autonomous vehicle compute 400), one or more devices of fleet management system 116, one or more devices of vehicle-to-infrastructure system 118, one or more vehicle-to-infrastructure devices 110, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

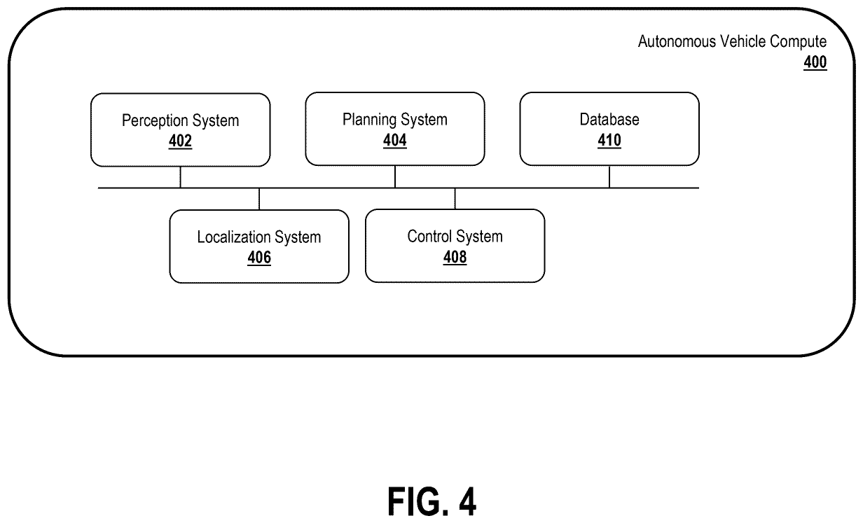

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

### Route Traversal Using Remote Vehicle Assistance

Some autonomous or semi-autonomous vehicles (referred to collectively as “autonomous vehicles”) navigate partially by remote operation. For example, a vehicle may receive a baseline route/trajectory from a remote operator, the baseline route/trajectory defining a general path to be followed by the vehicle, but the vehicle may autonomously deviate from the baseline route/trajectory and/or determine timing of navigation of the baseline route/trajectory based on sensor data, such as sensor data obtained by the perception system 402 and provided to the planning system 404. Additionally, or alternatively, a vehicle may typically navigate autonomously, but may request assistance from a remote operator when the vehicle encounters a condition to which an autonomous system of the vehicle cannot reliably adapt. In such a situation, the remote operator may temporarily assume partial or full control of vehicle navigation, or otherwise provide remote assistance/commands (RVA commands) to aid in the vehicle's navigation of the condition, and the vehicle can resume autonomous navigation when the condition is no longer present.

However, when remote vehicle control is used, any latency or message loss in communication between the vehicle and the remote operator may result in an unsafe scenario. For example, there may be a temporal mismatch between the remote operator's knowledge of a state of the environment (e.g., positions of vehicles) and the state of the environment when RVA commands are executed, leading to a potential for collisions. As another example, if remote operation is terminated unexpectedly, a vehicle may be left in an unsafe location. These dangers exist not only for direct-drive remote operation (e.g., remote operation of steering and/or pedals, such as remote operation of or remote commands to control system 408) but also for indirect remote operation (e.g., remote provision of waypoints, trajectories, and/or routes, such as remote operation of or remote commands to planning system 404).

To avoid unsafe scenarios associated with high latency or other network failures, remote operation may be forbidden when network conditions satisfy a threshold, e.g., when network latency is above a threshold value. However, this may undesirably limit the locations and/or situations in which autonomous vehicles are operable. As a very simple solution, a vehicle may simply halt movement when remote operation is unavailable; however, in that case, the vehicle may be left in an unsafe state (e.g., in the middle of an intersection or on a highway) and/or in a state that harms other road users (e.g., blocking a crosswalk or a traffic lane).

Accordingly, some embodiments according to this disclosure facilitate atomic, time-insensitive remote operator input for autonomous vehicles. Remote instructions/commands (e.g., RVA messages) are checked for compliance with one or more safety conditions, e.g., to ensure that remotely-provided trajectories are safe for traversal. In addition, or alternatively, trajectories are navigated segment-by-segment, where each segment is traversed only if the vehicle can stop safely (perform a “safe stop”) at the end of the segment. If network access to a remote operator becomes unavailable during traversal of the segment, and/or if a condition arises that prevents traversal of a subsequent segment, the vehicle can be controlled to perform the safe stop at a location that reduces or eliminates safety risks to the vehicle and other road users, until network access to the remote operator is again available to aid in the vehicle's navigation. Accordingly, autonomous vehicles can operate safely under conditions of unreliable network access.

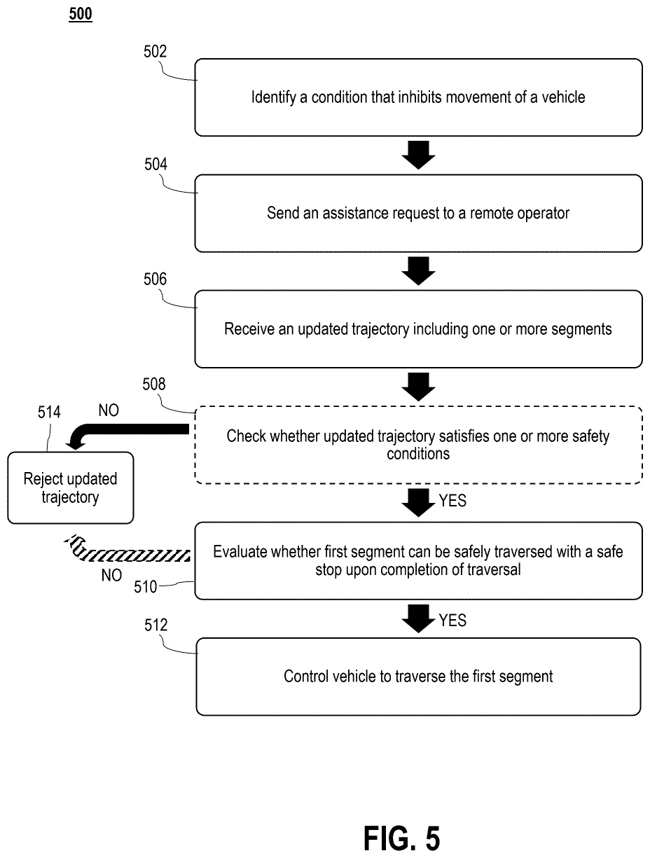

Referring now to FIG. 5, illustrated is a flowchart of a process 500 for route traversal using remote vehicle assistance. In some embodiments, one or more of the steps described with respect to process 500 (e.g., some or all of the steps) are performed by (e.g., completely, partially, and/or the like) by a computing system of a vehicle, e.g., by autonomous system 202 or autonomous vehicle compute 400 of vehicle 102 or 200. The process 500 can be performed by a computing system in a vehicle (e.g., one or more processors in the vehicle) in the context of autonomous vehicle operation with unreliable and/or high-latency network access to a remote operator. Additionally, or alternatively, in some embodiments one or more of the steps described with respect to process 500 are performed (e.g., completely, partially, and/or the like) by another device or group of devices separate from a computing system of a vehicle, e.g., by a vehicle-to-infrastructure device 110, a fleet management system 116, and/or a vehicle-to-infrastructure system 118. In the following descriptions, description of a vehicle performing an action is also disclosure of a computing system (e.g., a computing system of the vehicle) controlling the vehicle to perform the action. For example, a description that “the vehicle performs a safe stop” is also disclosure that “the computing system (or, e.g., one or more processors) controls the vehicle to perform a safe stop.”

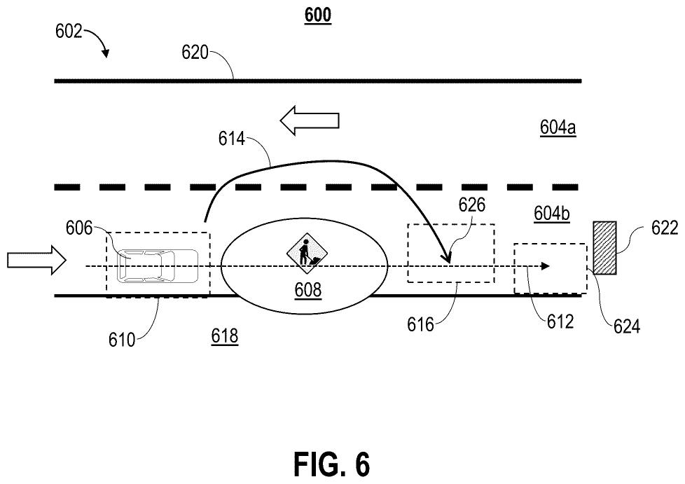

In the process 500, a computing system identifies a condition on a route traveled by a vehicle, the condition inhibiting movement of the vehicle along the route (502). For example, referring now to FIG. 6, an environment 600 includes a road 602 having a first lane 604a and a second road lane 604b having opposite navigation directions indicated by arrows. An autonomous vehicle 606 travels autonomously on a route 612 down the second road lane 604b (e.g., without remote assistance), until sensor(s) of the vehicle 606 detect a construction zone 608 blocking the second road lane 604b. A computing system of the vehicle 606 identifies that the construction zone 608 inhibits movement of the vehicle 606 along the route 612.

Various vehicular and/or environmental conditions can be identified as inhibiting movement of a vehicle along a route. Such conditions include, as non-limiting examples: debris and/or blockages from crashes; large potholes; road blocks due to construction or repair work; water or ice in the road; and barricades blocking roads closed to vehicular traffic. The condition can be detected using one or more sensors of the vehicle, e.g., using cameras 202a, LiDAR sensors 202b, and/or radar sensors 202c providing data received by perception system 402, which analyzes the sensor data to identify the condition.

In some embodiments, identifying the condition inhibiting movement of the vehicle includes determining that the vehicle cannot continue autonomous navigation given the presence of the condition. Not all unexpected road conditions require remote assistance: for example, traffic may inhibit movement of the vehicle, but the computing system of the vehicle can adapt to the traffic and continue traveling along the route. As another example, an autonomous vehicle that detects another vehicle in the process of parking can stop, wait for the other vehicle to finish parking, and then continue traveling along its route, without requiring remote assistance. By contrast, entirely-autonomous navigation in the presence of some conditions may be hazardous, e.g., if the navigation requires the vehicle to navigate into a lane with oncoming traffic or navigate through an intersection in an unusual manner that may not be autonomously recognizable by the computing system. In some embodiments, the computing system analyzes sensor data and determines whether remote assistance is necessary. For example, planning system 404 may obtain data from the perception system 402 and autonomously generate a trajectory to be traversed by the vehicle, along with a confidence that the trajectory is correct and/or safe; if the confidence is below a threshold value, the computing system determines that remote assistance is necessary.

In some embodiments, following identifying the condition (e.g., at least partially in response to identifying the condition), the vehicle performs a safe stop in a first safe stop location. As shown in FIG. 6, the vehicle 606 performs a safe stop in a first safe stop location 610. A safe stop location, such as safe stop location 610, is a location in which a vehicle may be stopped for an extended period of time (e.g., at least one minute or at least several minutes) while remaining in a safe state. The safe state can be based on safety of the vehicle itself, safety of other road users (e.g., in some embodiments, a crosswalk or a bicycle lane cannot be a safe stop location, because stopping in the crosswalk or bicycle lane puts pedestrians or cyclists at risk), and/or effect of the stopped vehicle on road traffic. Non-limiting examples of safe stop locations include road shoulders, available parking spots, designated vehicle stopping points, and low-speed road lanes. Low-speed road lanes can include road lanes having a speed limit or average vehicle speed below a threshold value; on such roads, a vehicle may remain stopped for an extended period of time without causing safety problems (e.g., because other vehicles have ample time to react to the stopped vehicle), whereas a stopped vehicle on a faster road lane (e.g., a highway lane) may present a safety hazard. In some embodiments, a safe stop location is defined based on the safe stop location leaving room for other vehicles to pass a stopped vehicle. For example, a low-speed road lane may be a safe stop location for a two-lane one-way road, but not for a one-lane one-way road where a stopped vehicle would fully block the single lane. In some embodiments, a safe stop location is defined based on a probability of collision for a vehicle stationary at the safe stop location. For example, the computing system may identify a location as a safe spot location only if the associated collision probability for the safe spot location is less than a threshold value. In addition to or instead of these considerations, a safe stop location can be identified based on a quantity of vehicle traffic through or near the safe stop location, and/or another characteristic.

Referring again to FIG. 5, following identifying the condition on the route traveled by the vehicle, the computing system sends an assistance request to a remote operator of the vehicle through a communications network that communicably couples the vehicle to the remote operator (504). For example, autonomous vehicle compute 202f or 400 uses communication device 202e to send an assistance request to a remote operator (e.g., fleet management system 116) over network 112. In some embodiments, the assistance request is sent while the vehicle is traversing a segment of a trajectory or traveling along a route, while the vehicle is navigating to a safe stop location to perform a safe stop, or while the vehicle is stopped at the safe stop location. In response to sending the assistance request, the computing system receives, from the remote operator, an updated trajectory for the vehicle to travel along the route, the updated trajectory including one or more segments (506). For example, communication device 202e receives an RVA message from the remote vehicle operator over network 112 and provides the RVA message to autonomous vehicle compute 202f or 400.

In some embodiments, if the computing system fails to connect to the remote operator to send the assistance request, or if the computing system does not receive the updated trajectory (e.g., due to network connection problems), the computing system can send one or more further assistance requests, e.g., periodically send assistance requests. Because the vehicle is in a safe stop location or can autonomously navigate to a safe stop location, the vehicle can wait safely until access to RVA messages from the remote assistance is restored.

The updated trajectory can be a trajectory that the vehicle can temporarily traverse in order to avoid/remove the condition identified as inhibiting travel along the vehicle's route, such that, after completion of traversal of the updated trajectory, the vehicle can resume autonomous navigation. In some embodiments, the updated trajectory deviates from the vehicle's route. For example, the updated trajectory can guide the vehicle around an obstacle to an opposite side of the obstacle, guide the vehicle on an unusual lane-merge or path through an intersection until the vehicle is again in a clearly-designated lane, or guide the vehicle in an environment lacking clear signage until the signage resumes. In some embodiments, the updated trajectory further includes a trajectory along the route itself; that is, the updated trajectory need not be limited to temporary navigation to avoid or respond to the identified condition but, rather, may include one or more portions that could be autonomously navigated by the vehicle in the absence of remote assistance.

The remote operator can have various characteristics in various embodiments. In some embodiments, the remote operator is an automated remote operator. The automated remote operator can include one or more computing systems (e.g., a cloud computing system) that, based on access to more data and/or more computing resources than the computing system in the vehicle, can determine an updated trajectory for the vehicle to follow; the computing system of the vehicle may be unable to determine the updated trajectory or unable to determine the updated trajectory with a sufficiently high confidence. In some embodiments, the remote operator is a human remote operator. For example, the human remote operator can receive the assistance request at a console, access sensor data (such as live video) from the vehicle and/or other sources (e.g., roadside cameras in proximity to the vehicle), and draw the updated trajectory on a digital map of the environment. In some embodiments, the remote operator includes both automated and human elements.

The updated trajectory can be provided in various formats suitable for processing by the computing system of the vehicle to control movement of the vehicle. In some embodiments, the updated trajectory includes one or more locations between which the vehicle navigates and/or one or more headings along which the vehicle navigates. In some embodiments, the updated trajectory includes one or more nodes, each node defined by a location and a heading, and the updated trajectory travels along the nodes in sequence based on the headings.

Referring again to FIG. 6, the vehicle 606 receives an updated trajectory 614 from the remote operator. The updated trajectory 614 extends from the second road lane 604b, into the first road lane 604a around the construction zone 608, and back into the second road lane 604b, at which point the vehicle 606 can resume travel along the route 612, absent other condition(s) that prevent resumption.

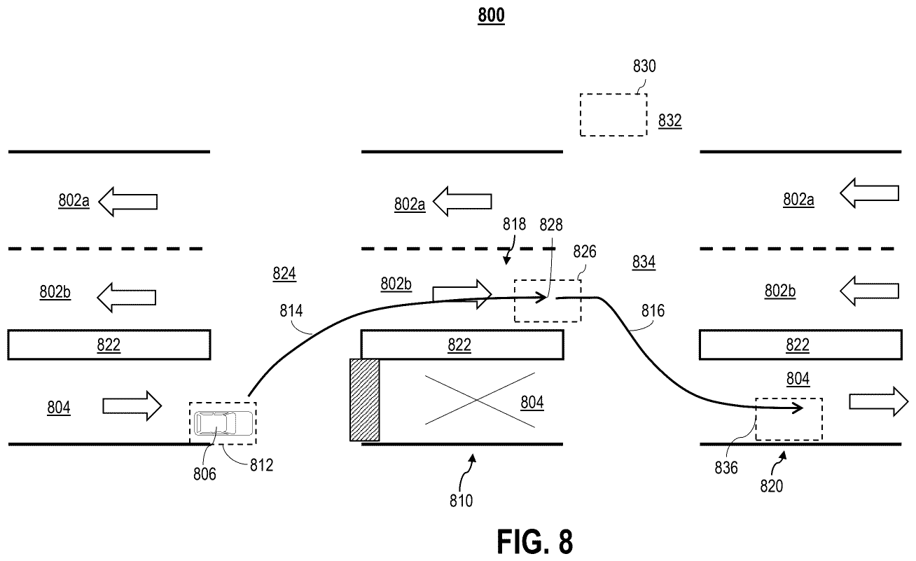

The updated trajectory received from the remote operator is composed of (e.g., divided into) one or more segments. When the updated trajectory is composed of a single segment, the single segment represents the entirety of the updated trajectory. When the updated trajectory is composed of multiple segments, the multiple segments are ordered in an ordering of consecutive segments that together form the updated trajectory, e.g., where an end of one segment marks a beginning of a next segment. The one or more segments can be indicated in the updated trajectory as-received at the vehicle (e.g., in data of one or more RVA messages by the vehicle) and/or the one or more segments can be defined by the computing system of the vehicle based on the updated trajectory and based on analysis of the environment, as described in further detail below in reference to FIG. 8. In the example of FIG. 6, the updated trajectory 614 includes a single segment.

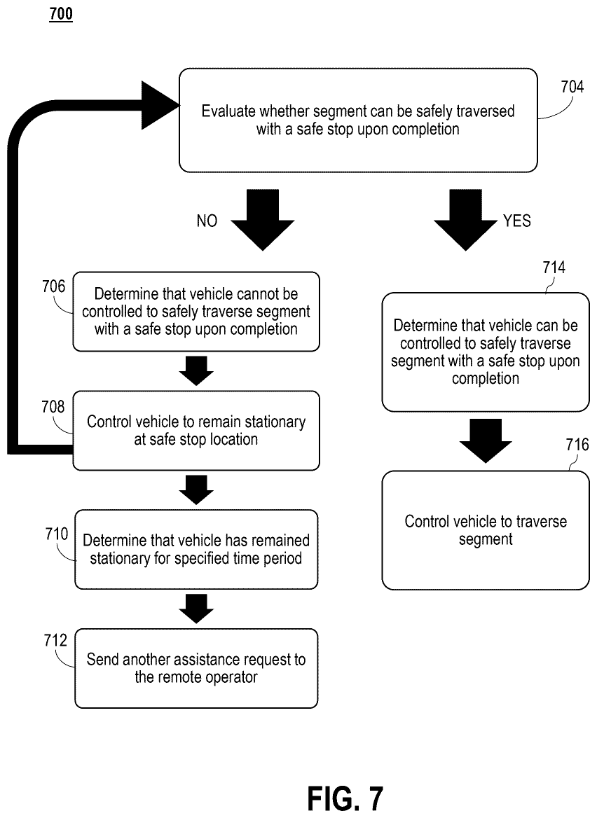

The vehicle, upon receiving the updated trajectory, may not immediately undertake traversal of the updated trajectory. Rather, the vehicle may first perform one or more checks (e.g., as described in reference to elements 508 and/or 510 of FIG. 5 and/or as described in reference to FIG. 7) to confirm that the updated trajectory is safe to navigate, is authentic, and/or provides the vehicle with a safe stop location, as described in more detail below.

In some embodiments, the computing system (e.g., the computing system of the vehicle) checks the updated trajectory, to confirm whether the updated trajectory satisfies one or more safety conditions (508). The safety conditions can include one or more of: whether the updated trajectory returns the vehicle to the vehicle's original route; whether the updated trajectory stays on drivable surfaces; whether the updated trajectory intersects any stationary objects; whether the updated trajectory satisfies one or more driving rules; whether the updated trajectory satisfies one or more cryptographic authentication checks; and/or other safety condition(s). In some embodiments, if the updated trajectory fails to satisfy one or more safety conditions, the updated trajectory is rejected (514), e.g., is not traversed by the vehicle.

Whether the updated trajectory returns the vehicle to the original route can be determined by comparing the updated trajectory to the original route. For example, in the example of FIG. 6, updated trajectory 614 deviates from the route 612 but returns to the route 612 after the construction zone 608. Accordingly, it can be determined that the updated trajectory 614 satisfies that safety condition.

Whether the updated trajectory stays on drivable surfaces can be checked by comparing the updated trajectory to a stored map of the environment that indicates drivable and non-drivable surfaces (e.g., a map stored in database 410), and/or by checking for non-drivable surfaces using sensor data (e.g., images/video of the environment) and determining whether the updated trajectory would include navigation on the non-drivable surfaces. Examples of non-drivable surfaces include sidewalks, curbs, bicycle lanes, and road-adjacent surfaces such as grass, fields, and ditches. For example, in reference to FIG. 6, the computer system of the vehicle 606 can confirm that the updated trajectory 614 does not enter an off-road area 618.

Whether the updated trajectory intersects any stationary objects can be checked by comparing the updated trajectory to locations of known stationary objects in the environment. The locations of the known stationary objects can be stored based on previously-collected data (e.g., stored in database 410), and/or the locations can be detected using sensor data gathered by the vehicle to identify the stationary objects, e.g., using sensors 202a, 202b, and/or 202c. Examples of stationary objects include road signs and other infrastructure, structures such as buildings, parked cars, road barriers/dividers, walls, and trees. In some embodiments, checking for intersection with stationary objects includes checking whether the updated trajectory passes within a minimum distance from a stationary object, e.g., within 0.4 meters of a parked car. For example, in reference to FIG. 6, the computer system of the vehicle 606 can confirm that the updated trajectory 614 does not collide with, or come within a threshold distance from, a wall 620 that partially delimits the first road lane 604a. While these collision checks may, in some embodiments, include a consideration of non-stationary objects, such as moving cars and pedestrians, consideration of non-stationary objects is described herein in the context of evaluating whether a segment can be safely traversed, e.g., in reference to element 510 of FIG. 5 and in reference to FIG. 7.

Whether the updated trajectory satisfies one or more driving rules can be determined by comparing the updated trajectory to driving rules. The driving rules can be stored based on previously-collected data (e.g., stored in database 410), and/or the driving rules can be determined by the computing system based on sensor data indicating road signage, traffic lights, workers directing traffic, etc. For example, the driving rules can indicate one-way roads on which the updated trajectory should not traverse, do-not-enter signs that the updated trajectory should not violate, and restricted turn lanes that the updated trajectory should not violate.

Whether the updated trajectory satisfies one or more cryptographic authentication checks can be determined by analyzing one or more RVA messages that, received at the vehicle, provided the updated trajectory to the vehicle. Checking the cryptographic authentication can confirm, for example, whether the updated trajectory is complete (e.g., whether any data indicative of the updated trajectory failed to be received at the vehicle) and/or whether the updated trajectory is authentic (e.g., whether the updated trajectory was in fact provided by the remote operator as opposed for, for example, a malicious middleman actor or other spoofer). In some embodiments, checking the cryptographic authentication can include executing a checksum algorithm based on the RVA messages, executing a cryptographic key check (e.g., verifying that the RVA messages are signed by a private key associated with the remote operator), and/or performing another check.

In some embodiments, the computing system determines whether the updated trajectory has been completely received. For example, the updated trajectory can be received in one or more RVA messages, and the computing system can determine whether a specified number of such RVA messages has been received or whether a series of the RVA messages includes data indicating an end of the series. This check can prevent the vehicle computing system from executing partial RVA commands, which may exacerbate an uncertain situation for the vehicle. In response to determining that the updated trajectory has been completely received, the computing system can continue performing its current process, e.g., check whether one or more safety conditions are satisfied (508) and/or evaluate whether a first segment of the trajectory can be safely traversed with a safe stop upon completion (510). In some embodiments, the completeness of the received updated trajectory is checked using a cryptographic authentication check, as described above.

Note that some embodiments do not include the optional checking of whether the updating trajectory satisfies the one or more safety conditions (508). Moreover, in some embodiments, one or more of the safety conditions are checked by another entity besides the computer system (e.g., the computer system in the vehicle) that performs other elements of process 500. For example, one or more of the safety conditions can be checked by the remote operator before the remote operator provides the updated trajectory to the computer system. However, in some cases, it may be preferable to have the computer system in the vehicle check the safety conditions, because the computer system in the vehicle has access to real-time sensor data obtained by vehicle sensors for comparison to the updated trajectory.

Referring again to FIG. 5, the computing system evaluates whether the vehicle can be controlled to safely traverse a first segment of the one or more segments of the updated trajectory with a safe stop upon completion of traversal of the first segment (510). This evaluation can include two distinct elements: whether the first segment can be traversed safely at a given time (e.g., given current traffic conditions), and, separately, whether the vehicle can perform a safe stop upon completion of traversal of the first segment.

The evaluation of whether the vehicle can perform a safe stop upon completion of traversal of the first segment relates to vehicle operation in conditions of unreliable access to the remote operator, e.g., conditions of poor wireless network connectivity. Consider a situation in which the vehicle, while traversing a segment, loses network access to the remote operator. If the vehicle encounters a new condition that the vehicle cannot handle autonomously, the vehicle will be unable to continue navigation, as the vehicle will be unable to receive RVA messages indicative of a new updated trajectory. However, in general, the vehicle may not immediately be able to come to a safe stop, either—for example, if stopping the vehicle would strand the vehicle in a lane with oncoming traffic. The result can be unsafe and unreliable autonomous vehicle behavior.

To avoid these situations, the vehicle does not execute traversal of the first segment without determining that the vehicle can, if necessary, perform a safe stop upon completion of traversal of the first segment. Based on this, if, upon reaching the end of the first segment, the computing system of the vehicle determines that continued travel on the vehicle's route cannot be performed autonomously (e.g., if a new condition arises that inhibits travel on the route), and if the remote operator is unavailable, the vehicle can simply perform the safe stop and wait. e.g., until the remote operator is again available to provide an updated trajectory to the vehicle.

For example, in reference to FIG. 6, an obstacle 622 blocks the route 612. While the vehicle 606 traverses the first segment of the updated trajectory 614 (in this example, the entirety of the updated trajectory 614), sensor(s) of the vehicle 606 detect the obstacle 622, and the computing system of the vehicle 606 identifies the obstacle 622 as a condition inhibiting travel along the route 612. The computing system attempts to send an assistance request to the remote operator. However, due to poor cellular and/or Wi-Fi access, the remote operator is not available to provide another updated trajectory that avoids the obstacle 622. In response, the vehicle 606 can perform a safe stop at a second safe stop location 616. Before controlling the vehicle 606 to traverse the first segment of the updated trajectory 614, the computing system evaluates whether the vehicle 606 can be controlled to perform the safe stop upon completion of traversal of the first segment, and the computing system only causes traversal of the first segment upon determining that the safe stop would be possible. For example, in some embodiments, the computing system evaluates a speed limit along the second road lane 604b and determines, based on the speed limit, that the vehicle 606 can safely stop in the second road lane 604b, e.g., determines that the second safe stop location 616 is present. Evaluating whether the vehicle can perform a safe stop can include identifying one or more safe stop locations in proximity to a terminus of the to-be-traversed segment.

This segment-based analysis can be referred to as incorporating “atomic” operator input. Trajectories are divided into segments, each of which can be concluded with a safe stop. A vehicle embarks upon the trajectory and may, in the absence of obstacles or other inhibiting conditions and/or based on continued access to a remote operator, traverse the trajectory or an updated trajectory without stopping. However, the vehicle has the option of stopping at the end of any segment if remote operation is both necessary and unavailable. Moreover, the vehicle does not initiate traversal of any segment without confirming that the vehicle can, if necessary, perform a safe stop at the end of the segment. Accordingly, situations in which the vehicle (i) cannot navigate autonomously, (ii) cannot stop, and (iii) cannot obtain remote operation commands to guide navigation, are avoided. Correspondingly, the operator input is made time-insensitive, such that the vehicle operate even under conditions of poor network access.

Evaluation of whether the vehicle can perform a safe stop upon completion of traversal of the first segment can be based on various environmental features and other features. In some embodiments, the evaluation is based on whether a termination point of the first segment, and/or a terminal portion of the first segment (e.g., the last ten meters of the first segment) overlaps a safe stop location, such that the vehicle can stop directly during traversal of the first segment or upon finishing traversal of the first segment. In some embodiments, the evaluation is based on whether the vehicle can safely autonomously navigate to a safe stop location from the ending terminus of the first segment, e.g., where the safe stop location may be in proximity to the first segment but not necessarily directly overlap the first segment. For example, the first segment may terminate in a road lane, and a safe stop location may be located in an adjacent road shoulder to which the vehicle can directly autonomously navigate from the road lane. For example, in reference to FIG. 6, even in the absence of the second safe stop location 616 (e.g., if another vehicle is already stopped in the second safe stop location 616), the computing system of the vehicle 606 can determine that another safe stop location 624 is near the terminus 626 of the first segment (e.g., within a threshold distance of the terminus 626) and, in response, determine that the vehicle 606 can perform a safe stop upon completion of traversal of the first segment. By contrast, if the first segment terminated in the first road lane 604a where oncoming traffic would present a hazard to a stopped vehicle, the computing system could determine that the vehicle 606 could not perform a safe stop upon completion of traversal of the first segment.

In some embodiments, the evaluation of whether a safe stop can be performed upon completion of traversal of the first segment is a time-dependent evaluation, e.g., an evaluation of whether the safe stop can be performed at a current time and/or an evaluation of whether the safe stop can be performed if the vehicle begins traversal of the first segment at the current time (e.g., whether a safe stop location will be available upon completion of the traversal of the first segment, if the vehicle begins traversal of the first segment at the current time). For example, the evaluation can be based on sensor data collected by sensor(s) of the vehicle, the sensor data indicative of environment features and other road users. For example, the perception system 402 can obtain sensor data indicative of an availability of a parking spot or curbside area, determine the availability, and provide the availability to the planning system 404. If the parking spot or curbside area is occupied by a vehicle, then the parking spot or curbside area cannot currently be used to perform a safe stop, and the evaluation of whether a safe stop can be performed can be based on this determination. In some embodiments, the evaluation is based on sensor occlusion, e.g., whether sensor(s) to which the vehicle has access (e.g., vehicle sensors or infrastructure-based sensors) can detect the availability of a safe stop location. If no sensors can provide data to confirm the availability of a safe stop location at or in proximity to the terminus of the segment (e.g., if obstacles block the view of possible safe stop locations), it can be determined that a safe stop cannot be performed.

In some embodiments, if the computing system determines that a safe stop cannot be performed upon completion of traversal of the first segment, the updated trajectory including the first segment is rejected (514). In some embodiments, the vehicle can remain stationary at its current location (a safe stop location), and the evaluation can be performed again/periodically, e.g., as described in reference to FIG. 7.

The computing system further evaluates whether the first segment of the updated trajectory can be traversed safely, e.g., at a current time. In some embodiments, the evaluation is based on sensor data collected by sensor(s) of the vehicle, the sensor data indicative of objects such as other road user(s), e.g., other vehicles and/or pedestrians. The objects can include stationary objects. For example, the perception system 402 can obtain sensor data indicative of the other road users and identify the other road users. The planning system 404 can obtain data identifying the other road users from the perception system 402 and compare the other road users' positions, current trajectories, and/or predicted positions to the first segment. For example, for one or more other road users, the planning system 404 can predict a future trajectory for the other road user (for example “vehicle A will continue traveling forward at between 20 mph and 40 mph”) and determine, based on the predicted future trajectories, a probability that the road users will collide with the vehicle traversing the first segment or come within a threshold distance of the vehicle traversing the first segment. The determination can be based on current velocities of tracked objects. In some embodiments, if the probability is less than a specified low threshold value (e.g., 1%), it is determined that the vehicle can safely navigate the first segment. Other methods of determining whether the traversal is safe are also within the scope of this disclosure. In some embodiments, the evaluation is based on sensor occlusion, e.g., whether sensor(s) to which the vehicle has access (e.g., vehicle sensors or infrastructure-based sensors) can detect tracked objects with sufficient confidence and within a sufficient range. If no sensors can provide data to confirm that a collision with an object is unlikely, it can be determined that the traversal is unsafe.

In reference to FIG. 7, illustrated is a flowchart of a process 700 associated with evaluation of whether a segment can be safely traversed with a safe stop. The process 700 can be performed by one or more entities that perform the process 500, such as by a computing system of a vehicle. The process 700 can be performed at least partially during (e.g., at least partially as part of) performance of element 510 described in reference to FIG. 5. The process can be applied to a first segment of an updated trajectory (e.g., the first segment described in reference to FIG. 5) or to any other segment of an updated trajectory, such as a second segment that is traversed after the first segment. For example, upon completion of the first segment, a vehicle can perform a safe stop at a first safe stop location. The vehicle can then evaluate whether the second segment can be safely traversed with a safe stop, e.g., performing a process as described in reference to element 510 and/or the process 700.

In the process 700, a computing system evaluates whether a segment can be safely traversed with a safe stop upon completion of the traversal (704). The evaluation can be performed as described above, e.g., based on evaluation of sensor data and/or other data indicating whether a safe stop location is positioned at or in proximity to the terminus of the segment, whether a collision is likely during traversal of the segment, and/or another consideration. The evaluation can result in a determination that traversal is safe and a safe stop is possible (714) or a determination that traversal is not safe and/or that a safe stop is not possible (706).

If traversal is safe and a safe stop is possible upon completion of traversal, the computing system controls the vehicle to traverse the segment (716). If traversal is not safe or if the safe stop is not possible, the computing system controls the vehicle to remain stationary (708). e.g., to remain stationary at a safe stop location at which the vehicle is currently stopped. For example, the safe stop location can be a first safe stop location at which the vehicle performed a safe stop upon completion of traversal of a first segment of a multi-segment updated trajectory, and the segment under consideration in the process 700 can be a second segment, immediately following the first segment.

While the vehicle is stationary at the safe stop location, the computing system can reevaluate whether the segment can be safely traversed with a safe stop upon completion (704). For example, the computing system can perform the reevaluation continuously or periodically, e.g., every two seconds or every five seconds. When the reevaluation results in a determination that the segment can be safely traversed with a safe stop upon completion (714), the vehicle is controlled to traverse the segment (716).

For example, referring again to FIG. 6, the vehicle 606, stopped at the safe stop location 610, can repeatedly/periodically check whether there is incoming traffic in the first road lane 604a that would make the updated trajectory 614 unsafe to traverse. The vehicle 606 waits until it is safe to proceed (and until a safe stop can be performed upon completion, e.g., at the safe stop location 616), and, when it is safe, proceeds to traverse the updated trajectory 614.

In some embodiments, the computing system does not perform reevaluations indefinitely. Rather, in some embodiments, the computing system can determine that the vehicle has remained in the safe stop location for a specified time period, e.g., sixty seconds. In response, the computing system can send another assistance request to the remote operator (712). In some embodiments, the computing system operates a timer to track the duration for which the vehicle has remained stationary. The further assistance request can be a request to provide another updated trajectory that is safe to traverse with a safe stop upon completion, and/or the assistance request can be a request that the remote operator authorize on-location intervention, e.g., authorize a tow truck pickup of the vehicle. Because the vehicle is already stopped in a safe stop location, it is acceptable for the vehicle to remain stationary until on-location intervention arrives. Sending another assistance request to the remote operator can include rejecting the updated trajectory that includes the segment that is not safe to traverse with a safe stop upon completion (514).

Referring again to FIG. 5, upon determining that the vehicle can be controlled to traverse the first segment with a safe stop upon completion of traversal of the first segment, the computing system controls the vehicle to traverse the first segment (512). For example, the control system 408 can generate and transmit control signals to cause the powertrain control system, the steering control system, and/or the brake system to operate to navigate the vehicle along the first segment. Upon completion of traversal of the first segment, if the vehicle has completed its updated trajectory (e.g., is back on its original route), the vehicle can resume autonomous navigation without remote operation. If the vehicle has not completed its updated trajectory, the vehicle can evaluate a next segment in the updated trajectory and traverse the next segment when it is safe to do so with a safe stop, e.g., as described in reference to element 510 and process 700.

In reference to FIG. 8, illustrated is another example of a traffic situation associated with remote assistance. A vehicle 806 navigates through an environment 800 in which a pair of first road lanes 802a, 802b in which traffic travels in a first direction are separated from a second road lane 804 in which traffic navigates in a second direction. Dividers 822 separate the first road lanes 802a, 802b from the second road lane 804. The vehicle 806 follows a route through the second road lane 804 until sensors of the vehicle 806 detect the presence of an obstacle 808 that blocks access to a closed area 810 of the second road lane 804. The correct response is to follow signage to temporarily enter a detour area 818 of the first road lane 802b (which is repurposed to allow navigation in the same direction as the second road lane 804, as a detour) and then navigate back to the second road lane 804 at a reentry area 820. However, a computing system of the vehicle 806 determines that the vehicle 806 cannot continue navigating autonomously and, in response, the vehicle 806 performs a safe stop at a first safe stop location 812, e.g., as described in reference to element 502 of FIG. 5. In addition, the computing system sends an assistance request to a remote operator, e.g., as described in reference to element 504. In response to the assistance request, the computing system receives an updated trajectory including one or more segments, e.g., as described in reference to element 506.

In different embodiments and in different situations/environmental conditions, the received updated trajectory corresponding to the traffic situation of FIG. 8 can take different forms. In a first scenario, the updated trajectory includes only a first segment 814. In a second scenario, the updated trajectory includes two segments 814, 816, where the two segments are separately indicated in the updated trajectory or in one or more received RVA messages that indicate the updated trajectory. In a third scenario, the updated trajectory includes the path indicated by the two segments 814, 816, but without differentially indicating the two segments 814, 816. Processes corresponding to each scenario are described below.

In the first scenario, the vehicle 806 receives an updated trajectory that includes only the first segment 814, which terminates in the detour area 818. In some embodiments, the computer system of the vehicle 806 checks whether the first segment 814 satisfies one or more safety conditions, e.g., as described in reference to element 508. Note that, in this example, the vehicle 806 may not check whether the updated trajectory returns the vehicle 806 to its original route in the second road lane 804. If the safety conditions are satisfied (or, in some embodiments, without checking whether the safety conditions are satisfied), the computer system evaluates whether the first segment 814 can be safely traversed with a safe stop upon completion of traversal, e.g., at a current time, e.g., as described in reference to element 510 and/or in reference to process 700. For example, the computer system uses sensors of the vehicle 806 to track moving objects in a first intersection 824 and/or in the first road lanes 802a, 802b to determine whether a probability of collision is less a threshold value, and the computer system further evaluates whether a safe stop can be performed at the conclusion of traversal. For example, the computer system can identify the presence of a second safe stop location 826 at the terminus 828 of the first segment 814. As another example, the computer system can identify the presence of a third safe stop location 830 in a shoulder 832 of the first road lane 802. Although navigation to the third safe stop location 830 from the terminus 828 of the first segment requires navigation through the first road lane 802a, in some embodiments the computer system can determine (e.g., based on sensor data, stored mapping data, etc.) that this navigation can be performed autonomously (e.g., with a confidence above a threshold confidence). For example, in some embodiments, the evaluation of whether a safe stop can be performed upon conclusion of traversal of a segment includes an evaluation of whether the vehicle can safely autonomously navigate to a safe stop location upon conclusion of traversal.

Continuing in reference to the first scenario, during navigation of the first segment 814 (e.g., while the vehicle 806 is traveling in the first road lane 802b), the computing system determines that the vehicle 806 cannot autonomously navigate to the reentry area 820 through a second intersection 834. In response, the computing system can send a second assistance request requesting a second updated trajectory. The second assistance request can be sent while the vehicle 806 is in motion, or, if the condition inhibiting autonomous movement is detected too late to receive the second updated trajectory before reaching the second intersection 834, or if network access to the remote assistant is not available before reaching the second intersection 834, the vehicle 806 can be controlled to perform a safe stop, e.g., in the second safe stop location 826.

In some cases, the second updated trajectory including the second segment 816 is received while the vehicle 806 is still traveling through the second road lane 804, without having performed a safe stop. The computing system evaluates whether the second segment 816 can be traversed safely with a safe stop (and, in some embodiments, whether the second updated trajectory satisfies one or more safety conditions, e.g., as described in reference to element 508) and, if the result of the evaluation is positive, the vehicle 806 can be controlled to traverse the second segment 816 without first performing a safe stop. That is, given safe navigation conditions, vehicle travel can be continuous, without requiring a safe stop between segments. If the result of the evaluation is negative, or if the vehicle 806 has already performed a safe stop in the second safe stop location 826 before receiving the second updated trajectory, the vehicle 806 can be controlled to remain stationary in the second safe stop location 826 until the evaluation is positive, e.g., as described in reference to elements 706, 708, 710, and 712. In some embodiments, after one or more further evaluations, the evaluation is determined to be positive (e.g., the computing system determines that the second segment 816 can be traversed safely with a safe stop) and the computing system controls the vehicle 806 to traverse the second segment 816. The evaluation of whether the second segment 816 can be traversed safely with a safe stop upon conclusion of the traversal can be based on identifying a fourth safe stop location 836 at the terminus of the second segment 816 or at a location to which the vehicle 806 can autonomously navigate from the terminus of the second segment 816.

In the second scenario, the updated trajectory received by the vehicle 806 includes the two segments 814, 816, where the two segments are separately indicated in the updated trajectory or in one or more received RVA messages that indicate the updated trajectory. In the second scenario, the vehicle 806 can perform navigation as described in reference to the first scenario, except that the computing system need not send a second assistance request to obtain a second updated trajectory including the second segment 816. Rather, the computing system, while traversing the first segment 814, can evaluate the already-obtained second segment 816 to determine whether the second segment 816 can be safely traversed with a safe stop. If the result of the evaluation is positive, the vehicle 806 can traverse the second segment 816 without performing a safe stop. If the result of the evaluation is negative, the vehicle 806 can perform a safe stop in the second safe stop location 826 or the third safe stop location 830 until the second segment 816 is safe to traverse with a safe stop.

In the third scenario, the updated trajectory received by the vehicle 806 includes the path indicated by the two segments 814, 816, but the updated trajectory does not differentially indicate the two segments 814, 816. In some embodiments, the computing system performs a trajectory-segmentation process to divide a received trajectory into two or more segments. For example, the trajectory-segmentation process can be performed in response to the updated trajectory having a length over a threshold length and/or in response to the computing system determining that traversal of the updated trajectory is predicted to consume a time duration longer than a threshold time duration. In such situations, it can be desirable to segment/atomize the updated trajectory so as to introduce “checkpoints” associated with each segment, where the vehicle has the opportunity to perform a safe stop at the end of each segment, if necessary.

The updated trajectory can be segmented based on one or more parameters. In some embodiments, the updated trajectory is segmented such that each segment has a length that is at least a specified minimum length or a predicted travel time longer than a specified minimum travel time. This can be useful, for example, to avoid the vehicle traversing very short segments and performing many safe stops that are close to one another. In some embodiments, the updated trajectory is segmented such that each segment has a length that is less than a specified maximum length or a predicted travel time shorter than a specified maximum travel time. In some embodiments, the updated trajectory is segmented such that each segment has at least one of a specified length (e.g., 300 feet or 400 feet) or a specified travel time (e.g., ten seconds or twenty seconds, e.g., based on an assumed average travel speed).

In some embodiments, the updated trajectory is segmented based on safe stop location(s) in proximity to, or autonomously navigable from, the updated trajectory. Multiple safe stop locations can be identified (e.g., based on sensor data and/or stored mapping data), and the segments can be defined so that each segment corresponds to one or more safe stop locations to which the vehicle is able to autonomously navigate from the terminus of the safe stop location.

These properties that may define segments can define the segments whether the segments are determined by the computing system of the vehicle or by the remote operator.

In some embodiments, the updated trajectory is segmented fully by the computing system upon receiving the updated trajectory. In some embodiments, the updated trajectory is segmented at least partially after traversal of the updated trajectory has begun. For example, in reference to FIG. 8, the computing system of the vehicle 806 can receive an updated trajectory that extends along both segments 814, 816 (and, in some embodiments, extends past the second segment 816) without separately defining the two segments 814, 816. The computing system can check whether the updated trajectory satisfies one or more safety conditions: for example, the computing system can confirm that the updated trajectory returns to the vehicle's route along the second road lane 804 (based on the updated trajectory extending to the reentry area 820). The computing system can further identify the first segment 814 (in some cases without also identifying the second segment 816), determine that the first segment 814 can be safely traversed with a safe stop, and, in response, control the vehicle 806 to traverse the first segment 814.

In some embodiments, during traversal of the first segment 814 or while stopped at a safe stop location after traversal of the first segment 814, the computing system can “look ahead” in the updated trajectory and define a second segment (such as the second segment 816) that the vehicle 806 can safely traverse after the first segment 814, with a safe stop. Accordingly, in some embodiments, the second segment 816 can be determined based on transient factors such as safe spot location availability and/or the movement(s) of objects in the environment 800, e.g., as determined based on sensor data from sensor(s) of the vehicle 806. The computing system can use at least the sensor data to identify the second segment 816 based on one or more parameters, e.g., to cause the second segment 816 to have at least a specified minimum length and/or to ensure that at least one safe spot location can be autonomously navigated to from the terminus of the second segment 816.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method performed by one or more processors in a vehicle, the method comprising:
identifying a condition on a route traveled by the vehicle that inhibits movement of the vehicle along the route;
following identifying the condition on the route traveled by the vehicle, sending an assistance request to a remote operator of the vehicle through a communications network that communicably couples the vehicle to the remote operator;
in response to sending the assistance request, receiving, from the remote operator, an updated trajectory for the vehicle to travel along the route, the updated trajectory comprising one or more segments;
evaluating whether the vehicle can be controlled to safely traverse a first segment of the one or more segments with a safe stop upon completion of traversal of the first segment;
in response to the evaluating, determining that the vehicle can be controlled to safely traverse the first segment with a safe stop upon completion of the traversal of the first segment; and
upon determining that the vehicle can be controlled to traverse the first segment with a safe stop upon completion of the traversal of the first segment, controlling the vehicle to traverse the first segment.

2. The method of claim 1, further comprising:
controlling the vehicle to arrive at a first safe stop location upon completion of the traversal of the first segment; and
at a first time:
evaluating whether the vehicle can be controlled to safely traverse a second segment of the one or more segments with a safe stop upon completion of traversal of the second segment, the second segment following the first segment in an ordering of the one or more segments corresponding to the updated trajectory;
in response to the evaluating, determining that the vehicle cannot be controlled to safely traverse the second segment with a safe stop upon completion of the traversal of the second segment; and
upon determining that the vehicle cannot be controlled to traverse the second segment with a safe stop upon completion of the traversal of the second segment, controlling the vehicle to remain stationary at the first safe stop location.

3. The method of claim 2, further comprising, at a second time following the first time:
evaluating whether the vehicle can be controlled to safely traverse the second segment with a safe stop upon completion of the traversal of the second segment;
in response to the evaluating, determining that the vehicle can be controlled to safely traverse the second segment with a safe stop upon completion of the traversal of the second segment; and
upon determining that the vehicle can be controlled to traverse the second segment with a safe stop upon completion of the traversal of the second segment, controlling the vehicle to traverse the second segment.

4. The method of claim 2, further comprising, at a second time following the first time:
determining that the vehicle has remained stationary at the first safe stop location for a specified time period; and
in response to the determining, sending another assistance request to the remote operator of the vehicle through the communications network.

5. The method of claim 1, wherein identifying the condition on the route that inhibits movement of the vehicle along the route comprises:
identifying a presence of one or more obstacles in a section of the route.

6. The method of claim 1, further comprising determining that the updated trajectory satisfies one or more safety conditions,
wherein determining that the updated trajectory satisfies one or more safety conditions comprises determining that the updated trajectory, after deviating from a portion of the route, returns to the route.

7. The method of claim 1, further comprising determining that the updated trajectory satisfies one or more safety conditions,
wherein determining that the updated trajectory satisfies the one or more safety conditions comprises at least one of:
determining that the updated trajectory stays on a drivable surface of a road traveled by the vehicle along the route,
determining that the updated trajectory does not intersect one or more stationary objects,
determining that the updated trajectory satisfies one or more driving rules for traveling along the route, or
determining that the updated trajectory satisfies one or more cryptographic authentication checks.

8. The method of claim 1, wherein evaluating whether the vehicle can be controlled to safely traverse the first segment with a safe stop upon completion of the traversal of the first segment comprises at least one of:
determining that a probability of collision with one or more objects in a surrounding environment during traversal of the first segment is below a specified threshold, or
determining that a location for a safe stop of the vehicle is present at an end of the first segment or that the vehicle can navigate autonomously to the location for the safe stop from the end of the first segment.

9. The method of claim 8, wherein the one or more objects in the surrounding environment comprises at least one of:
one or more other moving vehicles,
one or more pedestrians, or
one or more stationary objects.

10. The method of claim 1-9, comprising:
determining completion of reception of the updated trajectory from the remote operator; and
in response to determining the completion of reception of the updated trajectory from the remote operator, determining whether the updated trajectory satisfies one or more safety metrics.

11. The method of claim 1, wherein evaluating whether the vehicle can be controlled to safely traverse the first segment with the safe stop upon completion of traversal of the first segment comprises identifying a safe spot location in proximity to an end of the first segment.

12. The method of claim 11, wherein identifying the safe spot location is based on at least one of:
a vehicle speed associated with a road on which the safe spot location is located,
a collision probability associated with the safe stop location, or
whether navigation around the safe stop location is possible.

13. The method of claim 1, wherein the first segment corresponds to a portion of the updated trajectory having at least one of a specified distance or a specified time to travel by the vehicle.

14. A system, comprising:
at least one processor in a vehicle, and
at least one non-transitory storage media storing instructions that, when executed by the at least one processor, cause the at least one processor to:
identify a condition on a route traveled by the vehicle that inhibits movement of the vehicle along the route;
following identifying the condition on the route traveled by the vehicle, send an assistance request to a remote operator of the vehicle through a communications network that communicably couples the vehicle to the remote operator;
in response to sending the assistance request, receive, from the remote operator, an updated trajectory for the vehicle to travel along the route, the updated trajectory comprising one or more segments;
evaluate whether the vehicle can be controlled to safely traverse a first segment of the one or more segments with a safe stop upon completion of traversal of the first segment;
in response to the evaluating, determine that the vehicle can be controlled to safely traverse the first segment with a safe stop upon completion of the traversal of the first segment; and
upon determining that the vehicle can be controlled to traverse the first segment with a safe stop upon completion of the traversal of the first segment, control the vehicle to traverse the first segment.

15. The system of claim 14, wherein the instructions, when executed by the at least one processor, cause the at least one processor to:
control the vehicle to arrive at a first safe stop location upon completion of the traversal of the first segment; and
at a first time:
evaluate whether the vehicle can be controlled to safely traverse a second segment of the one or more segments with a safe stop upon completion of traversal of the second segment, the second segment following the first segment in an ordering of the one or more segments corresponding to the updated trajectory;
in response to the evaluating, determine that the vehicle cannot be controlled to safely traverse the second segment with a safe stop upon completion of the traversal of the second segment; and
upon determining that the vehicle cannot be controlled to traverse the second segment with a safe stop upon completion of the traversal of the second segment, control the vehicle to remain stationary at the first safe stop location.

16. The system of claim 15, wherein the instructions, when executed by the at least one processor, cause the at least one processor to, at a second time following the first time:
evaluate whether the vehicle can be controlled to safely traverse the second segment with a safe stop upon completion of the traversal of the second segment;
in response to the evaluating, determine that the vehicle can be controlled to safely traverse the second segment with a safe stop upon completion of the traversal of the second segment; and
upon determining that the vehicle can be controlled to traverse the second segment with a safe stop upon completion of the traversal of the second segment, control the vehicle to traverse the second segment.

17. The system of claim 14, wherein the instructions, when executed by the at least one processor, cause the at least one processor to determine that the updated trajectory satisfies one or more safety conditions,
wherein determining that the updated trajectory satisfies the one or more safety conditions comprises at least one of:
determining that the updated trajectory stays on a drivable surface of a road traveled by the vehicle along the route,
determining that the updated trajectory does not intersect one or more stationary objects, determining that the updated trajectory satisfies one or more driving rules for traveling along the route, or
determining that the updated trajectory satisfies one or more cryptographic authentication checks.

18. The system of claim 14, wherein evaluating whether the vehicle can be controlled to safely traverse the first segment with a safe stop upon completion of the traversal of the first segment comprises at least one of:
determining that a probability of collision with one or more objects in a surrounding environment during traversal of the first segment is below a specified threshold, or
determining that a location for a safe stop of the vehicle is present at an end of the first segment or that the vehicle can navigate autonomously to the location for the safe stop from the end of the first segment.

19. The system of claim 14, wherein evaluating whether the vehicle can be controlled to safely traverse the first segment with the safe stop upon completion of traversal of the first segment comprises identifying a safe spot location in proximity to an end of the first segment.

20. At least one non-transitory storage media storing instructions that, when executed by at least one processor, cause the at least one processor to:
identify a condition on a route traveled by a vehicle that inhibits movement of the vehicle along the route;
following identifying the condition on the route traveled by the vehicle, send an assistance request to a remote operator of the vehicle through a communications network that communicably couples the vehicle to the remote operator;
in response to sending the assistance request, receive, from the remote operator, an updated trajectory for the vehicle to travel along the route, the updated trajectory comprising one or more segments;
evaluate whether the vehicle can be controlled to safely traverse a first segment of the one or more segments with a safe stop upon completion of traversal of the first segment;
in response to the evaluating, determine that the vehicle can be controlled to safely traverse the first segment with a safe stop upon completion of the traversal of the first segment; and
upon determining that the vehicle can be controlled to traverse the first segment with a safe stop upon completion of the traversal of the first segment, control the vehicle to traverse the first segment.
